(19) United States
(12) Patent Application Publication
(10) Pub. No.: US 2003/0201651 A1
(43) Pub. Date: Oct. 30, 2003

(54) Universal semitrailer fifth wheel and sliding tandem pin puller

(76) Inventor: Lou Lockhart, Plattsmouth, NE (US)

Correspondence Address: Stephen L. Smith, Patent Attorney, 2410 Harney Street, Omada, NE, 68131-3618, US

(21) Appl. No.: 10/135,706

(22) Filed: Apr. 30, 2002

(51) Int. Cl. B66F 3/00; B62D 53/08

(52) U.S. Cl. 294/17

(57) ABSTRACT

The fifth wheel assembly by which a semitrailer (trailer) is demountably coupled to the tractor of a tractor-trailer vehicle is releasably operated by a special decoupling tool which includes a lever bar or tube having a handle end opposite to a fulcrum end with an elongated hook member pivotally mounted therebetween and an extendable elongated hook member slidably attached to the elongated hook member. To unlock the fifth wheel assembly, to allow decoupling of the tractor and trailer, the extendable hook member is looped over the fifth wheel release handle and the fulcrum end of the lever bar or tube is placed in bearing engagement with a suitable side surface of the vehicle so movement of the lever bar or tube about its fulcrum end will pull the fifth wheel release handle, and, can be altered, by keeping the extendable elongated hook member in the unextended position so the elongated hook member can be used to engage the tandem release handle and so the movement of the lever bar or tube about its fulcrum end will pull the sliding tandem release pins to allow shifting of the weight distribution of the trailer load. There are primarily two manufacturing types of fifth wheel release handle mechanisms and the extendable elongated hook member when in the unextended position permits unlocking the fifth wheel of both manufacturing types. The Holland fifth wheel can be released with the extendable hook in the up or down position depending on the date of manufacture of the fifth wheel. When the hook needs to be in the up position you must lift and pull on the handle. On the Fontaine fifth wheel the extendable hook must be facing up to engage the fifth wheel release handle. Again you must lift and pull. There is a rubber, hard plastic, Neopreem or other suitable material wheel installed on the fulcrum end of the lever bar or tube to absorb shock and eliminate the dragging of metal against metal when placed against the side of the trailer.

### BACKGROUND OF TIE INVENTION

1. Field of the Invention

This invention relates to tools, and more particularly to decoupling tools for unlocking a fifth wheel assembly to allow decoupling of a trailer from a tractor and to allow the release of the sliding tandem lock pin.

2. Description of the Prior Art

In large highway transport vehicles of the tractor-trailer type, an assembly commonly referred to as a fifth wheel is mounted on the rear of the tractor for demountably coupling the trailer to the tractor. The fifth wheel assembly is a device which lockably receives a kingpin dependingly carried on the trailer and allows the trailer to pivotally turn relative to the tractor.

Fifth wheel assemblies vary somewhat depending on the manufacturer, but there are two basic types. Typically, the fifth wheel assembly will automatically lock the trailer's kingpin when the tractor is backed up to the trailer so as to engage the fifth wheel with the kingpin. There is a release handle which unlocks the kingpin that is manually operated. On the more common type of release mechanism the elongated hook member can be looped over the handle to release the fifth wheel.

On the second most common type of fifth wheel release mechanism the extendable hook member when in the unextended position operates the release mechanism with the hook in the up position for looped under engagement of the fifth wheel release handle.

Fifth wheels are heavily greased to reduce friction between the tractor and the trailer. Consequently, the underside of the trailer is extremely dirty, not to mention the grit and dirt from road travel. In winter the build up of ice makes the job even dirtier and more unpleasant. The use of this tool eliminates the need to get dirty under the trailer, eliminates the strain on the operators arm and back which are recurring problems with hand operation. This tool also makes the operation of the release handles significantly easier, particularly when the tractor and trailer are not perfectly lined up, thereby creating increased tension on the fifth wheel assembly. This tool reduces the time necessary to decouple and eliminates the need for repeated repositioning of the tractor-trailer to reduce the tension on the fifth wheel coupling system. As you can imagine this tool is particularly valuable as more and more women drivers are operating tractor-trailers and this tool allows them to perform the same duties as a very strong man.

Additionally, the sliding tandem can be released using the same tool by extending the second hook to engage the release handle which is farther under the trailer than the fifth wheel release handle The sliding tandem is a thick metal plate that can be shifted forward or back along the length of the trailer in order to redistribute the weight of the trailer between the drivers and the tandem rear wheel assembly of the trailer. The sliding tandem significantly increases the ability to balance the weight of the load and decrease the friction between the tractor and the trailer centered in the fifth wheel assembly.

The sliding tandem moves on two steel rails with four spring loaded release pins. The movement is backwards or forwards to adjust the weight on drivers and trailer tandems. In order to pull the release handle the tractor and trailer must be in a straight line.

A rubber, hard plastic or other suitable material or other suitable material wheel can be attached to the surface engaging means end of the lever bar or tube. The rubber, hard plastic or other suitable material wheel can be attached in a manner that allows the wheel to rotate or not. Either way the wheel provides a wear surface that lasts considerably longer than any prior art and is replaceable when worn out or broken by improper use. This is a significant improvement over any prior art.

The universality of the product is unique over any prior art and is extremely desirable to reduce the tools carried by the driver and eliminating the need for drivers to get under the trailer for routine operation.

Either one of the hook members (elongated or extendable) can be made to rotate to engage the second most common type of fifth wheel release mechanism however both the rotation and the extendibility required for universality can be accomplished through the same attachment means (the sleeves) and thereby simplifies manufacturing. There are several possible designs where a single hook means could be employed if it telescopes and rotates.

### SUMMARY OF THE INVENTION

The tool disclosed is used for operating the two most common types of fifth wheel release mechanisms to decouple a semitrailer from a tractor or to operate the release handle of the sliding tandem. Both are accomplished by placing the fulcrum end of the lever bar or tube against the side of the trailer and rotating the lever about the fulcrum to pull the hook and release handle, thereby using leverage.

In the preferred embodiment of the invention there is a rubber, hard plastic or other suitable material or other suitable material wheel attached on the fulcrum end as the surface engaging means which greatly aids in reducing friction and wear and tear. Also, there is an extendable hook attached to the pivoting hook that permits unlocking the fifth wheel of the second most common type of fifth wheel release mechanism while in the unextended position and when in the extended position the hook engages the sliding tandem release handle.

The decoupling tool of the present invention as described operates universally to release the two most common types of release mechanisms for fifth wheels and also to release the sliding tandem to adjust the weight distribution of the trailer over the back tandem wheels of the trailer.

It is an object of the present invention as described to eliminate the need for an operator to carry more than one decoupling tool. This universal tool takes less space and performs more functions.

It is an object of the present invention to reduce both wear and tear on the tool and the vehicle by placing a rubber, plastic or other suitable material wheel as the surface engaging means of the fulcrum end of the lever bar or tube. The wheel was not contemplated by the prior art. The significance of this is in the operation of the tool itself. One use in comparison with the proposed surface engagement means of the prior art demonstrates the ease of operation. The rubber, hard plastic, Neopreem or other suitable material wheel is also replaceable should wear and tear require replacement or it is broken due to misuse.

### BRIEF DESCRIPTION OF THE DRAWINGS

FIG. 1 is a side view of the preferred embodiment of the invention.

### DESCRIPTION OF THE PREFERRED EMBODIMENT

The preferred embodiment of the invention is a universal pin puller that engages the release handles of the two most common types of fifth wheel release mechanisms and the release handle of the sliding tandem release mechanism that are used under a semitrailer while placing the forces between the lever bar or tube 1 and the side of the semitrailer when actuating the release mechanism solidly on a rubber, hard plastic Neopreem or other suitable material wheel 3 on the fulcrum end of the lever bar or tube 1 as the surface engaging means.

The universality of the tool is obtained by attaching a second extendable hook 10 to the first hook 7 to permit the actuation of the second most common type of fifth wheel release mechanism in the unextended position and the actuation of the sliding tandem release mechanism in the extended position.

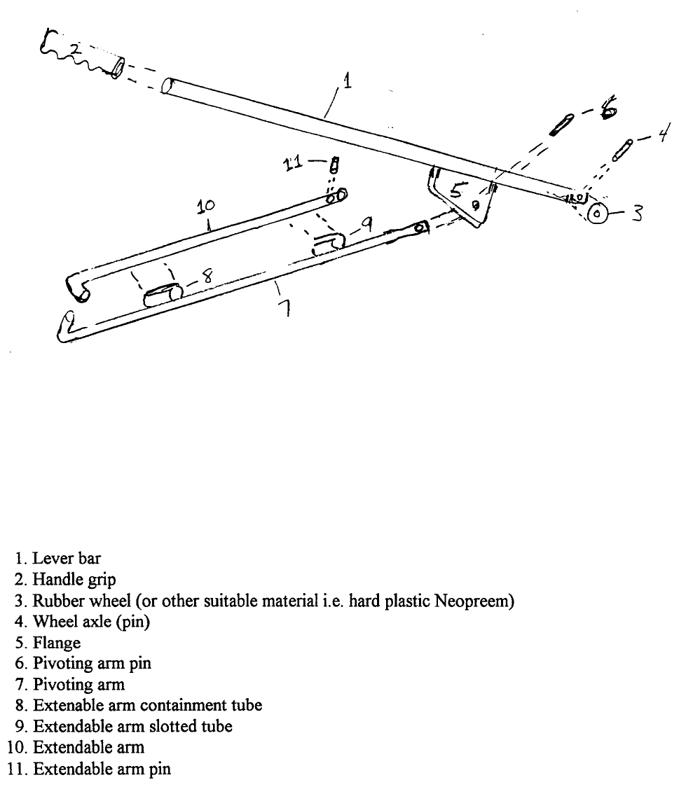

FIG. 1 illustrates the universal pin puller consisting of a lever bar or tube 1 with a fulcrum end and a handle end with two flanges 5 welded on the lever bar or tube 1 in the same longitudinal direction as the length of the lever bar or tube 1. An elongated hook member 7 is attached by pin 6 between the two flanges 5 so that it can pivot on the pin. The elongated hook member 7 is used to operate the most common type of fifth wheel release mechanism. Attached to the elongated hook member 7 is an extendable hook member 10 that when in the unextended position can be used to operate the second most common fifth wheel release mechanism or can slide out to extend the hook to a greater distance from the lever bar or tube 1 to enable engagement with the sliding tandem release handle and allow adjustment of the weight distribution of the semitrailer load between the driver and the tandem wheels on the rear of the semitrailer. The decoupling tool is shown in the unextended position in this figure. The extendable hook member 10 is attached to the elongated hook member 7 by means of two sleeves 8 & 9 welded to the elongated hook member 7. The sleeves 8 & 9 are short tubes slightly larger in diameter than the extendable hook member 10 to permit the extendable hook member 10 to slide. The sleeve 9 closer to the pivotal end of the elongated hook member 7 is slotted to allow the pin 11 on the extendable hook member 10 to slip through allowing full extension of the extendable hook member 10. The sleeve 8 closer to the hook end of the elongated hook member 7 does not have a slot thereby preventing the extendable hook member 10 from completely disengaging from the elongated hook member 7. The extendable hook member 10 can also rotate in the sleeves 8 & 9 to allow positioning of the hook for use in the unextended position with the looped under engagement means of the second most common type of fifth wheel release mechanism and in the extended position with the looped over engagement means of the sliding tandem release handle.

I claim, a decoupling tool for use in unlocking the two most common types of fifth wheel locking mechanisms and separating a semitrailer fifth wheel from a tractor, and for use in unlocking the sliding tandem of the semitrailer for weight distribution over the drivers and the tandem, said decoupling tool comprising

1. A tool for unlocking the fifth wheel of a tractor-trailer to allow decoupling of the tractor and trailer, which also has an extendable hook to permit the same tool to be used to pull the second most common type of fifth wheel release mechanisms in the unextended position and to pull the trailer sliding tandem lock pin in the extended position, comprising:
(a) an elongated lever bar or tube,
(b) a handle grip on the end of said lever bar or tube,
(c) a surface engaging means on the opposite end of said lever bar or tube for forming a fulcrum about which said lever bar or tube is moveable in an arc when said surface engaging means is placed in bearing engagement with a side surface of the tractor-trailer vehicle,
(d) an elongated rod pivotally mounted on one end thereof to said lever bar or tube intermediate said handle grip and said surface engaging, means,
(e) a hook means formed on the other end of said rod for looped over engagement of said release handle so that upon movement of said lever bar or tube said release handle will be pulled for unlocking of said fifth wheel, and
(f) a second hook means slidably attached to the first hook means that in the unextended position can be used for looped under engagement of the second most common type of fifth-wheel release mechanism and that in the extended position can be used for looped over engagement of said sliding tandem release handle so that upon movement of said lever bar or tube said sliding tandem release handle will be pulled for unlocking of said sliding tandem.

2. An improvement to tools for use in pulling fifth wheel and/or sliding tandem release handles under the trailer of a tractor trailer combination that use an elongated lever bar or tube with a handle end and a fulcrum end with an elongated rod pivotally mounted on one end thereof to said lever bar or tube intermediate said hand end and said fulcrum end, comprising:
(a) a rubber, hard plastic, Neopreem or other suitable material, wheel permanently attached on the fulcrum end of said lever bar or tube as a surface engaging means to permit rotation of said lever bar or tube entirely on the rubber, hard plastic or other suitable material or other suitable material wheel when engaging a side surface of the tractor-trailer vehicle to enhance the ease of motion and to reduce friction and wear and tear between the decoupling tool and the tractor-trailer vehicle.

3. An improvement to tools for use in pulling fifth wheel and/or sliding tandem release handles under the trailer of a tractor trailer combination that use an elongated lever bar or tube with a handle end and a fulcrum end with an elongated rod pivotally mounted on one end thereof to said lever bar or tube intermediate said handle end and said fulcrum end, comprising:
(a) a second hook means slidably attached to the first hook means that in the unextended position can be used for looped under engagement of the second most common type of fifth-wheel release mechanism and that in the extended position can be used for looped over engagement of said sliding tandem release handle so that upon movement of said lever bar or tube said sliding tandem release handle will be pulled for unlocking of said sliding tandem.
